(19) United States
(12) Patent Application Publication
(10) Pub. No.: US 2003/0131818 A1
(43) Pub. Date: Jul. 17, 2003

(54) Intake manifold paddle system

(76) Inventor: Kyle Gregoire, Windsor (CA)

Correspondence Address: RANDALL J. KNUTH, P.C., 3510-A Stellhorn Road, Fort Wayne, IN, 46815-4631, US

(21) Appl. No.: 10/101,079

(22) Filed: Mar. 19, 2002

Related U.S. Application Data
(60) Provisional application No. 60/349,132, filed on Jan. 16, 2002.

(51) Int. Cl. F02M 35/10

(52) U.S. Cl. 123/184.21

(57) ABSTRACT

The present invention relates to an apparatus and method for creating a monolithically or modular formed intake manifold paddle system for use in an engine. The intake manifold paddle system has a shaft or shaft portion with at least one paddle. Each of the paddles may have an elastomeric edge.

### BACKGROUND OF THE INVENTION

1. Field of the Invention

The present invention relates to a monolithically or modular formed intake manifold paddle system for use with an internal combustion intake manifold.

2. Description of the Related Art

Currently, an intake manifold intake manifold paddle system for an engine consists of two or more parts and those parts are made of steel. The intake manifold paddle system minimally consists of a shaft and one or more paddles. The paddles are connected to the shaft by welding, connection pins or some other means of connection.

The use of steel for making the shaft and paddles causes many problems. One problem is that when the paddle is moved to completely block the flow of fuel and/or air from exiting the internal combustion intake manifold and entering the intake of the engine, the steel paddle becomes worn from contacting the surrounding walls of the internal combustion intake manifold. The wear to the paddle can cause steel chips to fall off of the paddle and enter the engine intake and damage the engine. Also, the steel paddles do not seal very well so extra fuel and/or air can move past the paddle and into the intake which can cause an improper amount of fuel and/or air to enter the intake of the engine.

Another problem is that the steel parts make the intake manifold paddle system heavy which therefore makes the installation process more difficult. The weight of the steel intake manifold paddle system also causes the engine to be less fuel economic than a lighter intake manifold paddle system would provide to the engine.

The use of two or more parts for construction of the intake manifold paddle system causes problems as well. Assembling the intake manifold paddle system can be time consuming depending on the number of parts and the complexity of the design of the intake manifold paddle system. Also, the more parts the intake manifold paddle system utilizes, the higher the possibility of misconnection between those parts. The present invention solves these problems.

### SUMMARY OF THE INVENTION

The present invention comprises, in one form thereof, a monolithically or modular formed intake manifold paddle system for use in an engine. The intake manifold paddle system is comprised of a shaft portion having at least one paddle. Each of the paddles has an elastomeric edge.

The present invention comprises, in another form thereof, an intake manifold paddle system for use in an engine. The intake manifold paddle system is comprised of a non-metal shaft having at least one non-metal paddle. Each of the paddles has an elastomeric edge.

In another form of the present invention, the system may comprise a root paddle portion (unit) connected to one or more adjacent paddle unit portions. Such modular adjacent paddle units are connectable with adjacent paddle units thereby forming paddle assemblies of any desired length. Connections between the modular paddle units may be constructed from snap fit connections, tongue and groove connections, plastic welding, screw type formed fasteners or other fastening mechanisms. Bonding via chemical, adhesive or other mechanical bonding techniques may also be utilized.

The present invention comprises, in yet another form thereof, a method of creating a monolithically formed intake manifold paddle system for use in an engine. The first step of the method is providing a mold for the creation of a shaft having at least one paddle. The next step of the method is to insert a material into the mold to create the shaft having at least one paddle. The final step of the method is to insert elastomeric material into the mold to create an edge for each of the paddles.

An advantage of the present invention is that by utilizing an elastomeric edge on each of the paddles, a secure fit may be made between the paddles and the surrounding walls of the internal combustion intake manifold to allow for minimal excess fuel and/or air to flow past the edge of the paddle when the paddle is in the closed position.

Another advantage of the present invention is that by utilizing an elastomeric edge on each of the paddles, the elastomeric edge will not wear as quickly as a steel edge from contacting the surrounding walls of the internal combustion intake manifold and therefore, thereby having less risk of small parts of the paddle falling off of the paddle and into the engine intake.

A further advantage of one form of the present invention is that by constructing the shaft and paddles out of a non-metal material, the intake manifold paddle system is lighter in weight which makes the intake manifold paddle system easier to install. Also, with a lighter intake manifold paddle system, the engine will get better fuel economy than if the intake manifold paddle system was constructed of steel or another heavy metal.

Yet another advantage of one form of the present invention is that by forming the intake manifold paddle system monolithically, there is no assembly required. By eliminating the assembly process, any assembly problems and/or failures between the assembled parts are eliminated. Also, by eliminating the assembly of the intake manifold paddle system, the production of intake manifold paddle systems increases because of the elimination of time it takes to assemble the intake manifold paddle system.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a plan view of one form of the present invention;

FIG. 2 is a sectional view of the shaft in one form of the present invention;

FIG. 3 is a sectional view of the shaft in one form of the present invention;

FIG. 4 is a sectional view of the paddle in one form of the present invention;

FIG. 5 is a sectional view of the shaft in one form of the present invention;

FIG. 6 is a plan view of the intake manifold with one form of the intake paddle system without elastomeric edged paddles;

FIG. 7 is a sectional view of the shaft in relation to the upper part of the manifold and the lower part of the manifold in one form the present invention;

FIG. 8 is a sectional view of the shaft with the anti-chatter overmold in one form of the present invention;

FIG. 9 is a sectional view of the paddle with the elastomeric edge in one form of the present invention;

FIG. 10 is a sectional view of the paddle in one form of the present invention;

FIG. 11 is a sectional view of the paddle in one form of the present invention;

FIG. 12 is a sectional view of the paddle in one form of the present invention;

FIG. 13 is a sectional view of the paddle in one form of the present invention;

FIG. 14 is a flowchart showing one form of the present invention;

FIG. 15 is a fragmentary view of the modular embodiment of the present invention, showing a tongue and groove dovetail attachment mechanism between either a root portion 14′ and modular paddle unit 14 or two modular paddle units 14;

FIG. 16 shows alternate attachment mechanism between paddle units 14 in which the two units are joined via bonding or a snap fit; and

FIG. 17 shows an option between two paddle units via a screw fastener formed on one plastic paddle unit.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

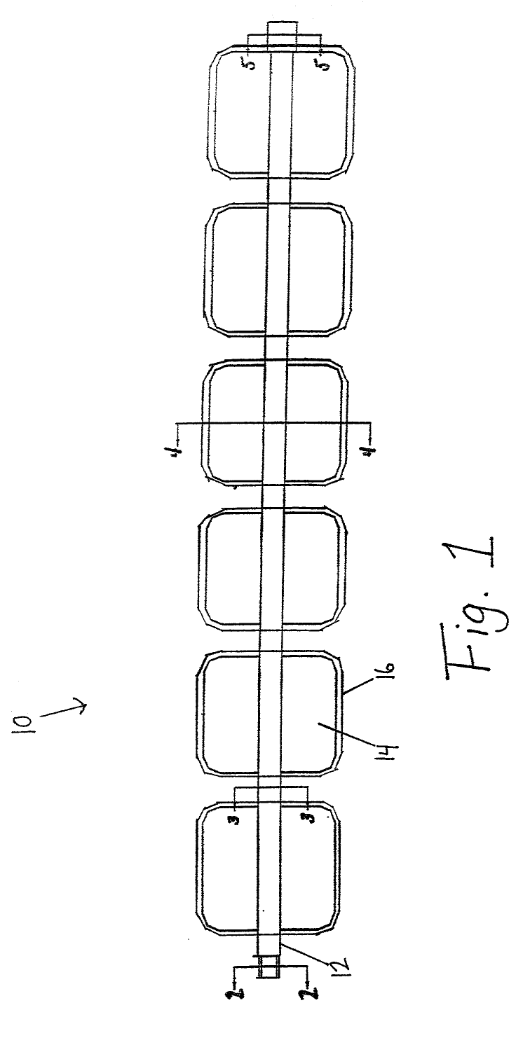

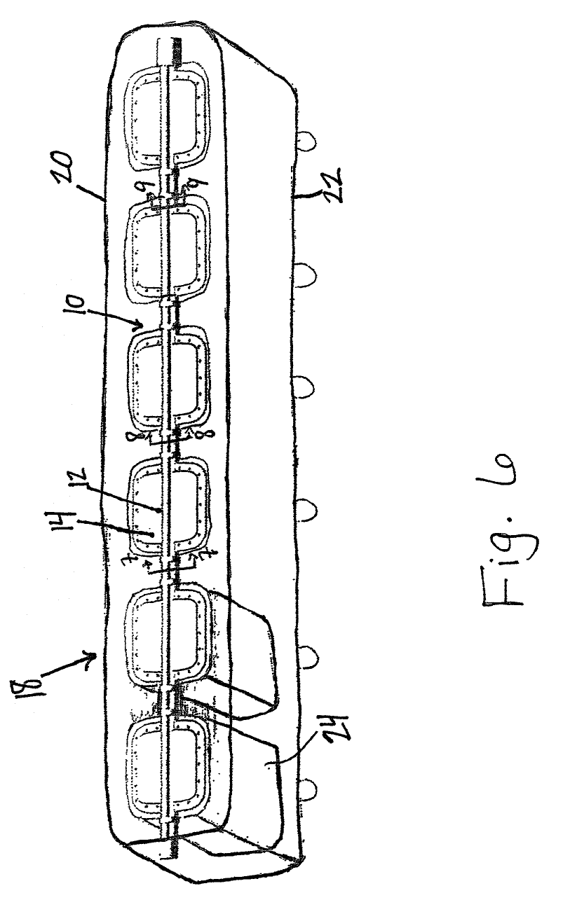

Referring now to the drawings and particularly to FIG. 1, there is shown a monolithically formed intake manifold paddle system 10 for use in an engine. Intake manifold paddle system 10 is created monolithically by utilizing a mold. Intake manifold paddle system 10 is located inside of intake manifold 18. Intake manifold 18 is shown in its environmental setting in FIG. 6 (FIG. 6 does not show an elastomeric edge around the paddle). Intake manifold 18 has an upper portion 20 and a lower portion 22. Intake manifold 18 also has a pathway 24 utilized to transfer fuel and/or air to the engine intake.

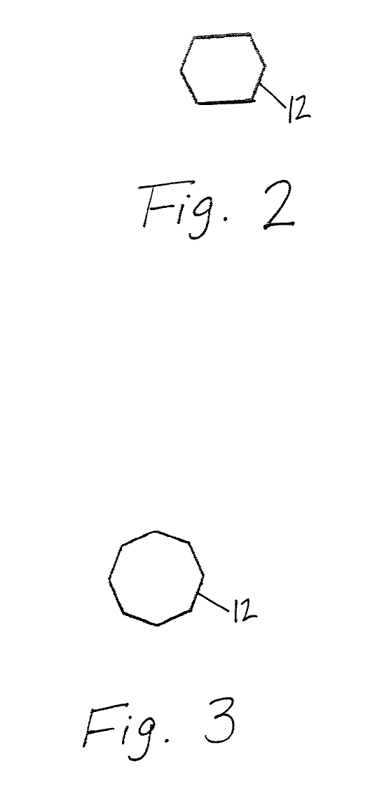

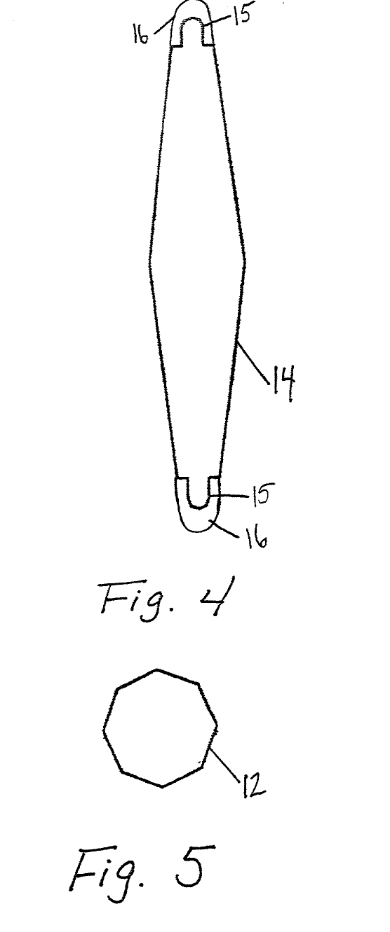

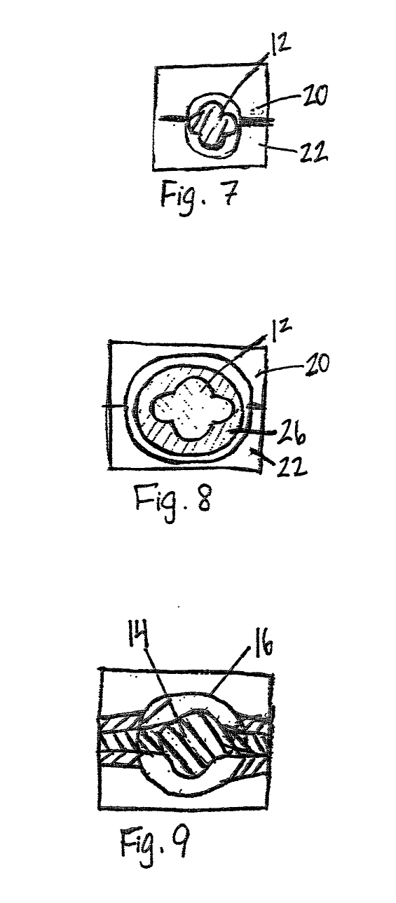

Intake manifold paddle system 10 is comprised of a shaft 12 and at least one paddle 14. Shaft 12 can be made of plastic or other types of materials as well such as metal. One end of shaft 12 is hexagon-shaped as shown in FIG. 2. This hexagon-shaped end is connected to a motor and the motor is used to rotate shaft 12. The opposite end of shaft 12 is octagon-shaped as shown in FIG. 5. The octagon-shaped end fits into a bearing so that shaft 12 can rotate. The remainder of shaft 12 is octagon-shaped as shown in FIG. 3. The shape of shaft 12 as well as the shape of the ends of shaft 12 can be other shapes as well. FIG. 7 shows the relationship between shaft 12, upper manifold 20 and lower manifold 22.

As was described above, intake manifold paddle system 10 has at least one paddle 14. Paddle 14 is shown in FIGS. 10 and 11. Paddle 14 is formed from a plastic, but can be constructed from other materials such as metal. Paddle 14 is generally square-shaped but is not limited to being square-shaped. The shape and the size of paddle 14 is dependent upon the size of intake manifold pathway 24 utilized to transfer fuel and/or air to the engine intake. Paddle 14 is utilized to seal, block and control flow through intake manifold pathway 24.

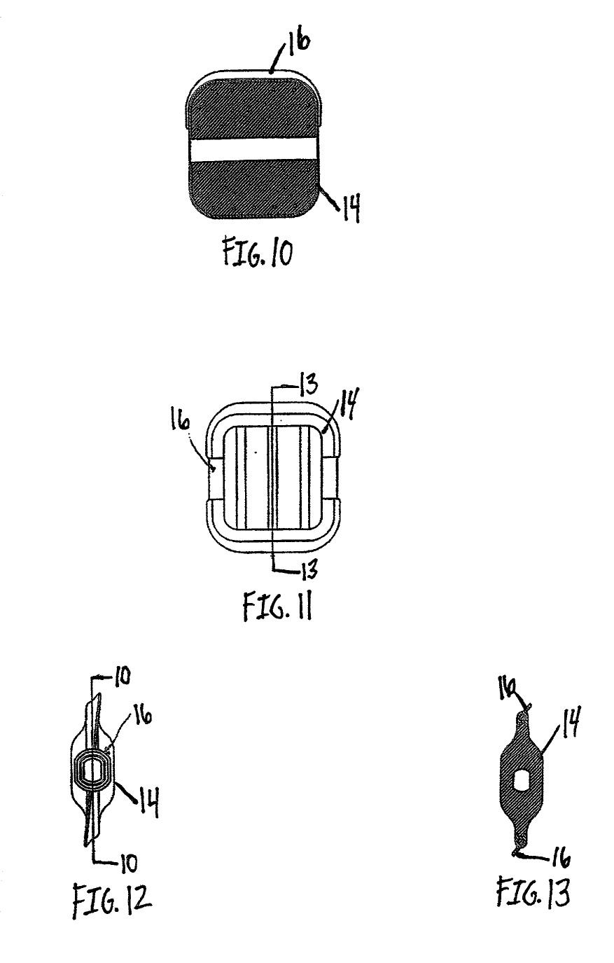

Paddle 14 has an edge 16, as shown in FIG. 9, and edge 16 is made from an elastomeric material. Elastomeric edge 16 is made from Hydrogenated Nitrile Rubber (HNBR) but other types of elastomeric material can be used as well. Some of the other types of elastomeric material that can be used are Natural Rubber, Polyisoprene Rubber, Styrene-butadiene Rubber, Ethylene-propylenediene Polymer, Isobutylene-isoprene Rubber, Polybutadiene Rubber, Polychloroprene Rubber, Nitrile Elastomer, Urethane Rubber, Fluro-Rubber (FKM), Silicone and Nitryl.

The elastomeric material can also be used on the circumference of shaft 12 to create an anti-chatter overmold 26. Anti-chatter overmold 26 is utilized to minimize the noise made from the use of intake manifold paddle system 10. FIG. 8 shows shaft 12 with anti-chatter overmold 26 which is formed at the same time elastomeric edge 16 is overmolded to paddles 14.

Intake manifold paddle system 10 is used to seal, block and control flow through intake manifold pathway 24 utilized to transfer fuel and/or air to the engine intake. Shaft 12 is rotated to allow the desired amount of fuel and/or air to enter the intake of the engine. If it is desired that no fuel and/or air enter the intake of the engine, shaft 12 is rotated so that elastomeric edge 16 is moved in to contact with the surrounding walls of intake manifold pathway 24. If intake manifold pathway 24 is blocked by intake manifold paddle system 10, and it is desired to have some amount of fuel and/or air enter the intake of the engine, shaft 12 is rotated to eliminate the contact between elastomeric edge 16 and the surrounding walls of intake manifold pathway 24 so that the fuel and/or air can reach the intake of the engine.

In another form of the present invention, shaft 12 and paddle 14 of intake manifold paddle system 10 are constructed from a non-metal material. Shaft 12 and paddle 14 are constructed from plastic. Other types of non-metal material can be used as well.

Paddle 14 can have a flange 15 on the top and bottom of paddle 14 for connection to elastomeric edge 16 as shown in FIG. 4, FIG. 12 and FIG. 13. Elastomeric edge 16 would have a groove wide enough to fit around flange 15 located on the top and bottom of paddle 14. This design of paddle 14 having flange 15 and elastomeric edge 16 having a groove allows for easy removal and replacement of elastomeric edge 16 when elastomeric edge 16 becomes worn.

Paddles 14 are formed to shaft 12 to complete intake manifold paddle system 10. In an alternate embodiment, paddle 14 can be welded to shaft 12 or paddle 14 can be connected to shaft 12 utilizing connecting pins. Other types of connecting devices can be used as well.

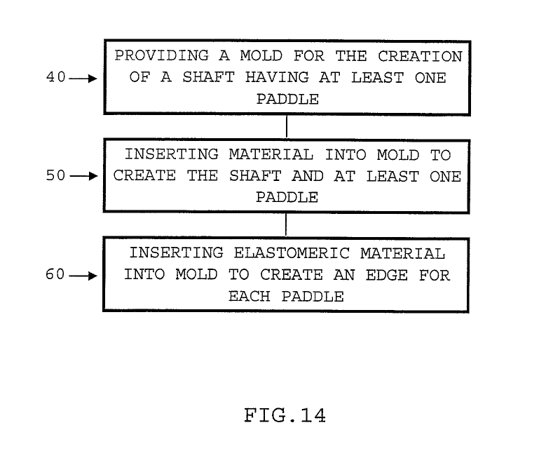

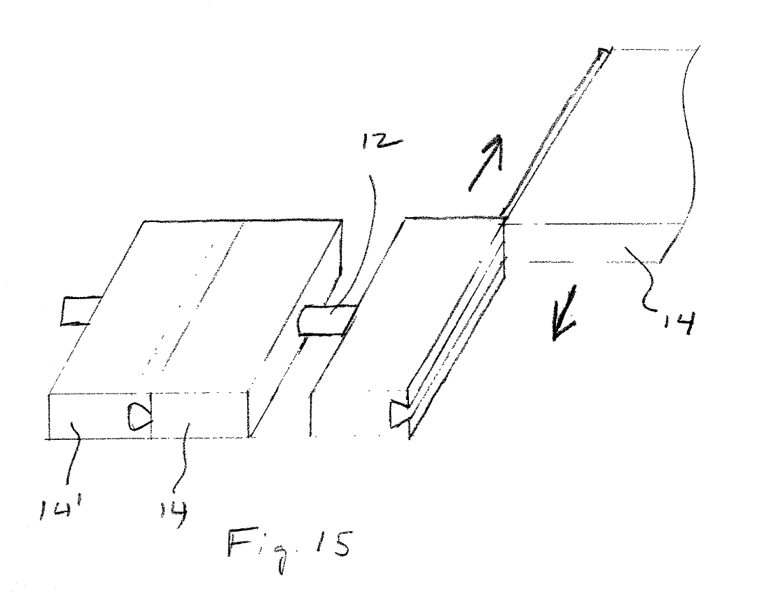

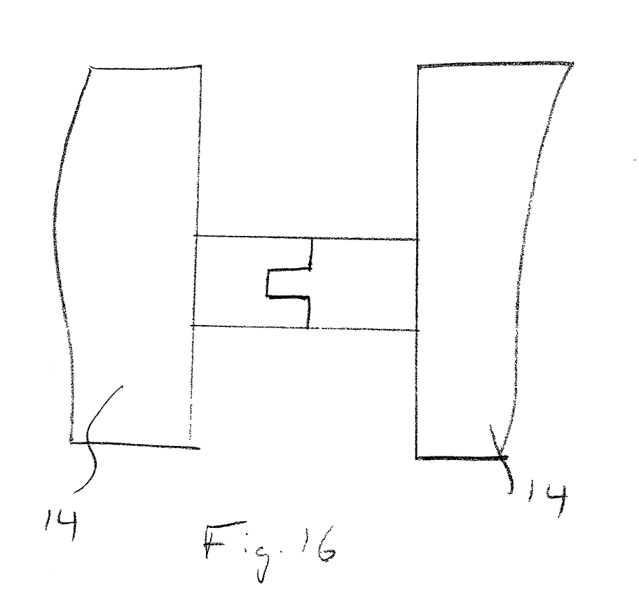

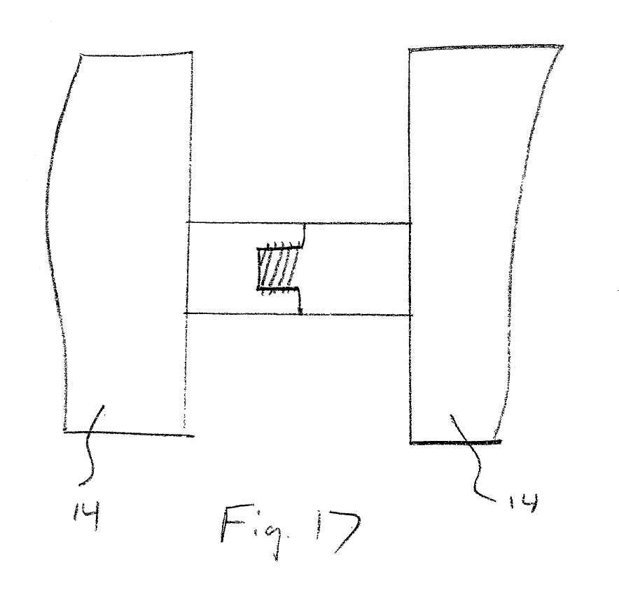

In yet another form of the present invention, there is a method of creating a monolithically formed intake manifold paddle system for use in an engine as shown in FIG. 14. The first step of the method is providing (40) a mold for the creation of a shaft having at least one paddle. The mold is designed so that the entire intake manifold paddle system is constructed monolithically.

The second step of the method is inserting (50) a material into the mold to create the shaft having at least one paddle. The material can be plastic or metal. Other types of material can be used as well. The material used to form both the shaft and each of the paddles can be injected into the mold. Other ways of inserting the material into the mold can be used as well. The materials used to create the shaft and the paddle are usually the same material but the paddle and shaft are not limited to being created using the same type of material.

The final step of the method is inserting (60) elastomeric material into the mold to create an edge for each paddle. The elastomeric material may be in liquid form and can be injected into the mold to form the edge of the paddle. The elastomeric material is HNBR but other types of elastomeric materials can be used such as Natural Rubber, Polyisoprene Rubber, Styrene-butadiene Rubber, Ethylene-propylenediene Polymer, Isobutylene-isoprene Rubber, Polybutadiene Rubber, Polychloroprene Rubber, Nitrile Elastomer, Urethane Rubber, Fluro-Rubber (FKM), Silicone and Nitryl.

The second and third step of the method can be reversed to create the intake manifold paddle system. The elastomeric material can be injected into the mold before the material utilized to form the shaft and the paddles is injected into the mold. Also, the elastomeric material can be in solid form and placed into the mold in preparation for the insertion of the material used to create the shaft and paddle.

In alternate embodiments, the plastic paddles may not have any elastomeric coating 16. Other embodiments may have the elastomeric coating connected to any portion of the paddle assembly including the shaft portion via over molding, o-rings assembled on to the shafts or snapped thereover.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A monolithically formed intake manifold paddle system for use in an engine, the system comprising:
a shaft having at least one paddle, each of said at least one paddle having an elastomeric edge.

2. The paddle system as recited in claim 1, wherein said shaft is made from plastic.

3. The paddle system as recited in claim 1, wherein said shaft is made from metal.

4. The paddle system as recited in claim 1, wherein said at least one paddle is made from plastic.

5. The paddle system as recited in claim 1, wherein said at least one paddle is made from metal.

6. The paddle system as recited in claim 1, wherein said elastomeric edge is rubber.

7. An intake manifold paddle system for use in an engine, the system comprising:
a non-metal shaft having at least one non-metal paddle, each of said at least one paddle having an elastomeric edge.

8. The paddle system as recited in claim 7, wherein said non-metal shaft is made from plastic.

9. The paddle system as recited in claim 7, wherein said at least one non-metal paddle is made from plastic.

10. The paddle system as recited in claim 7, wherein said elastomeric edge is rubber.

11. A method of creating a monolithically formed intake manifold paddle system for use in an engine comprising:
providing a mold for the creation of a shaft having at least one paddle;
inserting material into said mold to create said shaft having said at least one paddle; and
inserting elastomeric material into said mold to create an edge for each of said at least one paddle.

12. The method as recited in claim 11, wherein the material to create said shaft is plastic.

13. The method as recited in claim 11, wherein the material to create said shaft is metal.

14. The method as recited in claim 11, wherein the material to create said at least one paddle is plastic.

15. The method as recited in claim 11, wherein the material to create said at least one paddle is metal.

16. The method as recited in claim 11, wherein the elastomeric material is rubber.

17. The method as recited in claim 11, wherein inserting the material into said mold to create said shaft having said at least one paddle is performed utilizing an injector.

18. The method as recited in claim 11, wherein inserting the elastomeric material into said mold to create an edge for each of said at least one paddle is performed utilizing an injector.

19. An intake manifold system for use in an engine, the system comprising:
a root paddle unit; and
at least one modular paddle unit connectable to one of said root paddle unit and another modular paddle unit.
